(19) United States
(12) Patent Application Publication
(10) Pub. No.: US 2024/0142647 A1
(43) Pub. Date: May 2, 2024

(54) ENVIRONMENT INFORMATION ACQUISITION APPARATUS, ENVIRONMENT INFORMATION ACQUISITION METHOD, AND COMPUTER-READABLE MEDIUM

(71) Applicant: NEC Corporation, Minato-ku, Tokyo (JP)

(72) Inventor: Yutaka Yano, Tokyo (JP)

(73) Assignee: NEC Corporation, Minato-ku, Tokyo (JP)

(21) Appl. No.: 18/280,196

(22) PCT Filed: Mar. 5, 2021
(86) PCT No.: PCT/JP2021/008745

§ 371 Date: Sep. 1, 2023

(51) Int. Cl. G01V 1/28; G01V 1/22

(52) U.S. Cl. CPC G01V 1/288; G01V 1/226

(57) ABSTRACT

An environment information acquisition apparatus (400) according to the present disclosure includes an information acquisition unit (410) configured to receive, from an optical fiber (500), an optical signal including a pattern in accordance with environment information applied to the optical fiber (500) and acquire the environment information based on the optical signal; an information provision unit (430) configured to output measurement data representing the environment information to outside; and a detection unit (420) configured to detect vibration or sound applied to the information acquisition unit (410).

### TECHNICAL FIELD

The present disclosure relates to an environment information acquisition apparatus, an environment information acquisition method, and a computer-readable medium.

### BACKGROUND ART

### [Distributed Acoustic Sensing Technology]

A distributed acoustic sensing technology capable of detecting minute vibration and sound applied to a sensing optical fiber (hereinafter simply referred to as an “optical fiber”) will be described below.

Optical fiber sensing is performed by, for example, outputting pulsed probe light such as coherent light to an optical fiber, detecting and analyzing reflected return light from each part of the optical fiber, and acquiring, as environment information, disturbance (dynamic distortion) acting on the optical fiber. Reflected return light is constantly generated due to a scattering phenomenon such as Rayleigh scattering when probe light passes through an optical fiber. The optical fiber sensing acquires environment information from such reflected return light. In the optical fiber sensing, a measuring device configured to acquire environment information from reflected return light is called an interrogator.

Disturbance acting on reflected return light is typically an acoustic elastic wave propagating to an optical fiber. This optical fiber sensing technology is called distributed acoustic sensing (DAS). In DAS, an optical fiber serves as a sensor. Thus, the sensor in DAS is linearly distributed along the optical fiber. This is the reason why the optical fiber sensing technology is described as “distributed”. DAS technologies are disclosed in, for example, Patent Literatures 1 and 2 and Non Patent Literature 1.

DAS is classified as a sensing method of an OTDR scheme. OTDR is an abbreviation for optical time-domain reflectometry. In the OTDR scheme, the position of each reflection point on an optical fiber is determined based on the time difference between emission of probe light and returning of reflected return light thereof. When an excessive loss or an anomalous reflection point exists halfway through the path of the optical fiber, a change other than a change due to a transmission loss appears in the intensity of the reflected return light. Thus, the OTDR scheme is used in health check and anomalous point specification of the path of an optical fiber.

DAS is a kind of the OTDR scheme but has a difference that DAS measures a phase change of reflected return light distributively reflected and returning from an optical fiber.

### CITATION LIST

### Patent Literature

[Patent Literature 1] U.K. Patent No. 2126820
[Patent Literature 2] Japanese Unexamined Patent Application Publication No. 59-148835

### Non Patent Literature

[Non Patent Literature 1] R. Posey Jr, G. A. Johnson and S. T. Vohra, “Strain sensing based on coherent Rayleigh scattering in an optical fibre”, ELECTRONICS LETTERS, 28 Sep. 2000, Vol. 36 No. 20, p. 1688-P. 1689

### SUMMARY OF INVENTION

### Technical Problem

### [Application and Problem of Distributed Acoustic Sensing Technology]

The above-described distributed acoustic sensing technology can detect, for example, minute vibration and sound applied to a remotely placed optical fiber and thus is expected to be applied to, for example, earthquake and tsunami observation.

However, it is known that, when vibration or sound is applied to an interrogator, noise occurs which is added to entire measurement data representing environment information acquired by the interrogator and encumbers accurate measurement. One of its factors is thought to be fluctuation of light due to disturbance, the light being used as a reference when light interference measurement is performed inside the interrogator. To prevent this phenomenon, measures such as housing the interrogator in a vibration-proof and soundproof structural body are taken.

When vibration or sound applied to the interrogator cannot be sufficiently prevented, measurement data is anomalous, and for example, a false earthquake alert is issued, which has been a problem.

The present disclosure is intended to solve the above-described problem and provide an environment information acquisition apparatus, an environment information acquisition method, and a computer-readable medium that are capable of determining that measurement data of environment information is anomalous due to vibration or sound application to an interrogator.

### Solution to Problem

An environment information acquisition apparatus according to an aspect includes:
an information acquisition unit configured to receive, from an optical fiber, an optical signal including a pattern in accordance with environment information applied to the optical fiber and acquire the environment information based on the optical signal;
an information provision unit configured to output measurement data representing the environment information to outside; and
a detection unit configured to detect vibration or sound applied to the information acquisition unit.

An environment information acquisition method according to an aspect is an environment information acquisition method performed by an environment information acquisition apparatus and includes:
a step of receiving, by an information acquisition unit, from an optical fiber, an optical signal including a pattern in accordance with environment information applied to the optical fiber and acquiring the environment information based on the optical signal;
a step of outputting measurement data representing the environment information to outside; and
a step of detecting vibration or sound applied to the information acquisition unit.

A computer-readable medium according to an aspect is a non-transitory computer-readable medium storing a program for causing a computer to execute:
a procedure of receiving, by an information acquisition unit, from an optical fiber, an optical signal including a pattern in accordance with environment information applied to the optical fiber and acquiring the environment information based on the optical signal;
a procedure of outputting measurement data representing the environment information to outside; and
a procedure of detecting vibration or sound applied to the information acquisition unit.

### Advantageous Effects of Invention

The present disclosure can provide an environment information acquisition apparatus, an environment information acquisition method, and a computer-readable medium that are capable of determining that measurement data of environment information is anomalous due to vibration or sound application to an interrogator.

### BRIEF DESCRIPTION OF DRAWINGS

FIG. 1 is a conceptual diagram illustrating an exemplary entire configuration of an environment information acquisition system according to a first example embodiment;

FIG. 2A is a diagram illustrating an example of measurement data obtained by acquiring vibration applied to an optical fiber by distributed acoustic sensing (example in which vibration is applied to the optical fiber separated from an interrogator);

FIG. 2B is a diagram illustrating an example of measurement data obtained by acquiring vibration applied to an optical fiber by distributed acoustic sensing (example in which vibration is applied to the interrogator);

FIG. 3 is an explanatory diagram for description of an exemplary method of adding marks to measurement data of environment information acquired by the interrogator;

FIG. 4 is a conceptual diagram illustrating an exemplary configuration of an environment information acquisition apparatus according to the first example embodiment;

FIG. 5 is a flowchart for description of an exemplary process of operation of the environment information acquisition apparatus according to the first example embodiment;

FIG. 6 is a conceptual diagram illustrating an exemplary configuration of an environment information acquisition apparatus according to a fourth example embodiment; and

FIG. 7 is a conceptual diagram illustrating an exemplary hardware configuration of a computer that implements an environment information acquisition apparatus according to an example embodiment.

### EXAMPLE EMBODIMENT

Example embodiments of the present disclosure will be described below with reference to the accompanying drawings. Note that the following description and drawings include omission and simplification as appropriate for clarification of explanation. Identical elements in the drawings described below are denoted by the same reference sign, and duplicate description thereof is omitted as necessary.

### First Example Embodiment

### [Entire Configuration]

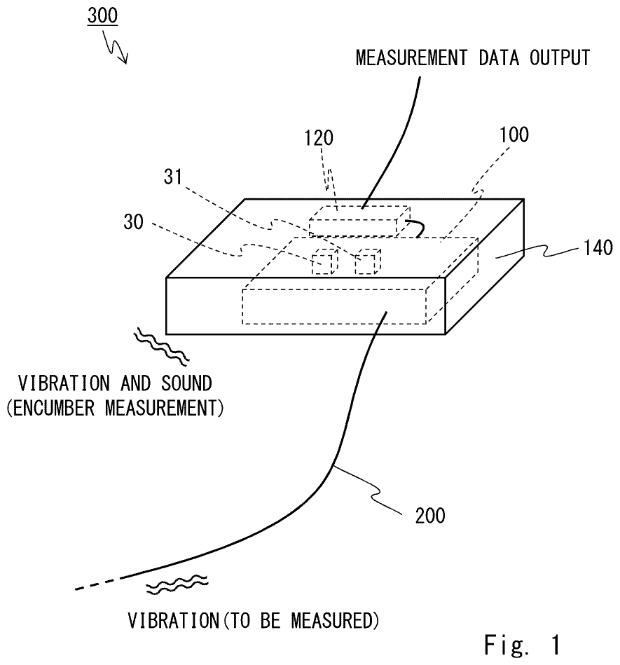

An exemplary entire configuration of an environment information acquisition system 300 according to the present first example embodiment will be described below with reference to FIG. 1. As illustrated in FIG. 1, the environment information acquisition system 300 according to the present first example embodiment includes an optical fiber 200 and an environment information acquisition apparatus 140. The environment information acquisition apparatus 140 includes an interrogator 100, an information provision unit 120, an acceleration sensor 30, and a microphone 31. Note that the interrogator 100 is an exemplary information acquisition unit, and the acceleration sensor 30 and the microphone 31 are exemplary detection units. In the example illustrated in FIG. 1, the environment information acquisition apparatus 140 has a housing structure in which the interrogator 100 is housed, and the information provision unit 120, the acceleration sensor 30, and the microphone 31 are also housed inside the housing structure.

The optical fiber 200 as a sensor is connected to the interrogator 100 in the environment information acquisition apparatus 140. Pulsed probe light is output from the interrogator 100 toward the optical fiber 200 and backscattered at each point on the optical fiber 200, and the backscattered light returns to the interrogator 100 as reflected return light. The interrogator 100 analyzes a pattern of the backscattered light and acquires environment information of each point on the optical fiber 200 at which the backscattered light is generated. Details of operation of the interrogator 100 will be described later. Measurement data representing the environment information acquired by the interrogator 100 is output to the outside through the information provision unit 120.

Consider a case in which the environment information acquired in the example illustrated in FIG. 1 is vibration. Environment information indicating the status of vibration sensed at each point on the optical fiber 200 is acquired by the interrogator 100. For example, the optical fiber 200 observes earthquakes over the length of 50 km.

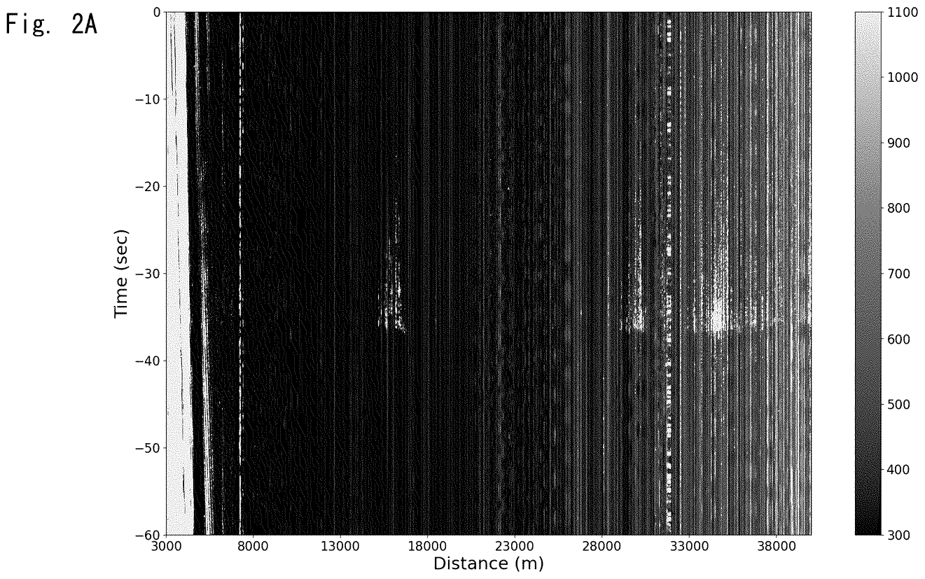

FIG. 2A illustrates an example of visualized measurement data of an earthquake detected by distributed acoustic sensing. The measurement data in FIG. 2A corresponds to an example in which the optical fiber 200 included in an optical submarine cable is used as a sensor. In the measurement data in FIG. 2A, the horizontal axis represents the distance from the interrogator 100 along the optical fiber 200 and the vertical axis represents elapsed time, and a newer state is illustrated at a higher place and an older state is illustrated at a lower place. The illustration corresponds to a status for one minute. The grayscale indicates the magnitude of vibration sensed at each point on the optical fiber 200. The left side is a shoreline, and it is observed that waves are arriving at the shoreline.

Propagation of vibration of the earthquake to the optical fiber 200 is observed at the vicinity of −35 second or later. A seismic wave propagates earliest to a place separated from the interrogator by 35000 m approximately and has high strength there, and thus it is thought that the place is close to the hypocenter.

Similarly to FIG. 2A, FIG. 2B illustrates an example of visualized measurement data when the interrogator 100 is shaken. In the measurement data in FIG. 2B, for example, the horizontal axis, the vertical axis, and the grayscale are the same as in FIG. 2A. However, the grayscale expressing vibration strength and the horizontal axis are displayed in an enlarged manner by narrowing their display ranges so that a phenomenon is clearly observed. In FIG. 2B, a horizontal bright line appears at each time point provided with an arrow on the right side. In this case, vibration is applied on the interrogator 100 side, not on the optical fiber 200 side. The continuation time of vibration applied to the interrogator 100 is short in this example and thus linear shapes are observed, but strip shapes are observed when the vibration is received for a longer time. Such simple determination of measurement data potentially leads to false determination that vibration is applied on the optical fiber 200 side and an earthquake is happening although the vibration is actually applied on the interrogator 100 side.

Thus, in the present first example embodiment, the acceleration sensor 30 and the microphone 31 are attached to the interrogator 100 as illustrated in FIG. 1. Vibration propagating to the interrogator 100 is detected by the acceleration sensor 30, sound propagating to the interrogator 100 is detected by the microphone 31, and results of the detection are transferred to the information provision unit 120. The acceleration sensor 30 and the microphone 31 are sensors implemented at the interrogator 100, different from the sensor as the optical fiber 200, and typically including electronic components. In this description, sound is a kind of vibration. Sound propagates mainly through air or water and vibration propagates mainly through ground, but both are phenomena that can shake the inside of the interrogator 100 from the outside. Note that a sensor only needs to be able to capture a phenomenon that shakes the interrogator 100 and encumbers accurate measurement, and not both the acceleration sensor 30 and the microphone 31 are necessarily essential. Only one of the acceleration sensor 30 and the microphone 31 may be used as long as an encumbering phenomenon can be sufficiently captured with the one.

When vibration or sound application to the interrogator 100 is detected by the acceleration sensor 30 or the microphone 31, the information provision unit 120 adds, to measurement data of environment information acquired by the interrogator 100, information that “vibration or sound not actually occurring to an optical fiber is potentially recorded”, in other words, reliability decrease information indicating decrease of the reliability of the measurement data. Specifically, the information provision unit 120 adds a mark representing the reliability decrease information to the measurement data of the acquired environment information across a time slot in which vibration or sound is detected by the acceleration sensor 30 or the microphone 31 attached to the interrogator 100. In this case, the information provision unit 120 may determine that vibration or sound large enough to encumber accurate measurement by the interrogator 100 is applied, when vibration or sound equal to or larger than a predetermined threshold value is applied to the interrogator 100.

In this manner, when a mark representing reliability decrease information is added to measurement data of environment information, a system that receives the measurement data output from the information provision unit 120 can switch actions based on the reliability decrease information. For example, a system that issues an earthquake alert can avoid issuing a false alert by, for example, excluding measurement data with low reliability as an alert determination target.

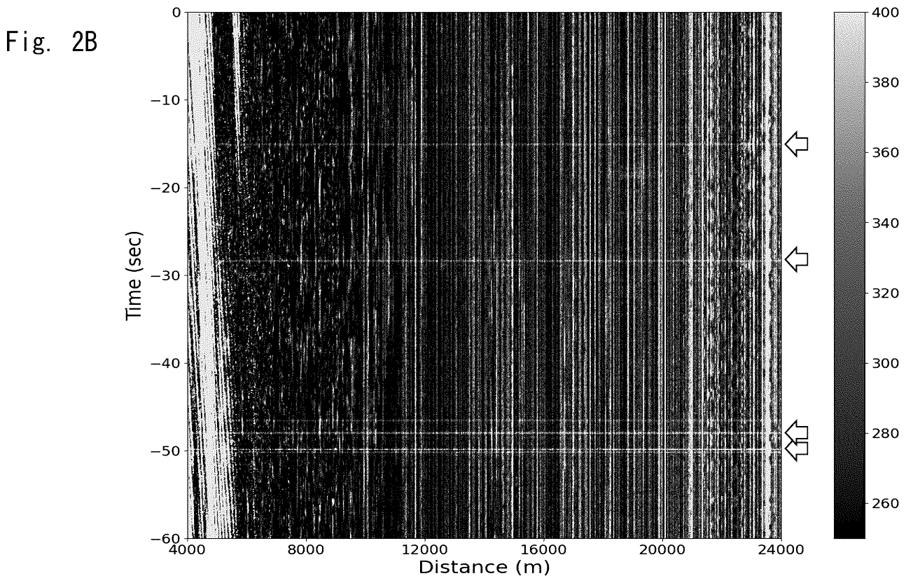

FIG. 3 is an explanatory diagram of an exemplary method of adding marks to measurement data of environment information acquired by the interrogator 100. The measurement data is constituted by frames in the unit of one second and has a format that a header region is provided at start of each frame. A particular area of the header region is determined as a place at which the value of a mark indicating detection of vibration or sound application to the interrogator 100 is to be written. The value of the particular area is normally set to “0”. The information provision unit 120 sets the value of the particular area to “1” for a duration in which vibration or sound is sensed by the interrogator 100 and the reliability is decreased. However, the value of the particular area may be set not only to two values but also to a value in accordance with a degree. For example, the value of the particular area is set to any value of “1” to “9” in accordance with the magnitude of shake.

Measurement data of vibration or sound applied to the interrogator 100 or data obtained by thinning the measurement data may be stored in the particular area of the header region described above. This is useful for a configuration in which determination of reliability decrease of measurement data and calculation that removes influence of vibration or sound applied to the interrogator 100 from measurement data, which will be described later are not performed inside the environment information acquisition apparatus 140 but performed by a following system.

Alternatively, the information provision unit 120 may stop outputting of measurement data across a time slot in which vibration or sound is detected by the interrogator 100, or may perform processing of filling measurement data with a value meaning invalidity across the time slot. However, valid information potentially remains in measurement data even when part of the measurement data lacks due to noise superimposition, and thus it is typically desired to continue transmission of measurement data of environment information as normal.

Needless to say, it is desirable that the reliability of measurement data does not decrease. Thus, it is fundamental to provide vibration-free and soundproof measures to the housing structure housing the interrogator 100 so that vibration and sound do not propagate to the interrogator 100. It is desirable to perform, for vibration or sound propagating despite the measures, the procedure of adding reliability decrease information to measurement data as in the present first example embodiment.

### [Configuration and Operation of Interrogator 100]

The configuration and operation of the interrogator 100 will be described below in detail.

The interrogator 100 is an interrogator for performing optical fiber sensing of the OTDR scheme.

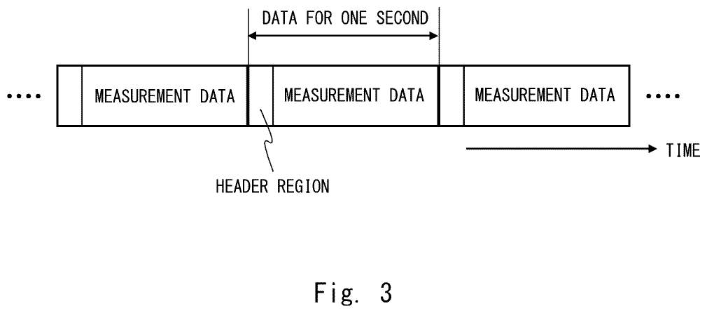

FIG. 4 is a conceptual diagram illustrating an exemplary configuration the environment information acquisition apparatus 140 according to the present first example embodiment. As illustrated in FIG. 4, the environment information acquisition apparatus 140 according to the present first example embodiment includes the interrogator 100 and the information provision unit 120. The interrogator 100 includes an acquisition processing unit 101, a synchronization control unit 109, a light source unit 103, a modulation unit 104, and a detection unit 105. Note that illustrations of the acceleration sensor 30 and the microphone 31 are omitted in FIG. 4.

The modulation unit 104 and the detection unit 105 are connected to the optical fiber 200 through an optical fiber 201 and an optical coupler 211 and through an optical fiber 202 and the optical coupler 211, respectively.

The light source unit 103 includes a laser beam source and outputs a continuous laser beam to the modulation unit 104.

In synchronization with a trigger signal from the synchronization control unit 109, the modulation unit 104 generates probe light having a sensing signal wavelength by modulating, for example, the amplitude of the continuous laser beam output from the light source unit 103. The probe light is, for example, in pulses. Then, the modulation unit 104 outputs the probe light to the optical fiber 200 through the optical fiber 201 and the optical coupler 211.

The synchronization control unit 109 sends a trigger signal to the acquisition processing unit 101 as well to convey the time origin of data continuously subjected to analog/digital (A/D) conversion.

When the probe light is output to the optical fiber 200, scattered light is generated at each position on the optical fiber 200, and backscattered light among the scattered light becomes reflected return light and reaches the detection unit 105 from the optical coupler 211 through the optical fiber 202. Among the reflected return light from the positions on the optical fiber 200, light from a position closer to the interrogator 100 reaches the interrogator 100 in a shorter time since the probe light is output. In a case in which a position on the optical fiber 200 is affected by an environment such as vibration or sound presence, a change from the probe light at the time of outputting occurs to backscattered light generated at the position because of the environment. The change is mainly a phase change when the backscattered light is Rayleigh backscattered light.

The reflected return light to which the phase change has occurred is detected by the detection unit 105. The detection can be performed by, for example, well-known synchronization detection and delay detection methods, but may be performed by any method. A configuration for performing the phase detection is well known, and thus description thereof is omitted here. An electric signal (detection signal) obtained through the detection indicates the degree of the phase change by amplitude or the like. The electric signal is input to the acquisition processing unit 101.

First, the acquisition processing unit 101 generates digital data from the above-described electric signal through A/D conversion. Subsequently, the acquisition processing unit 101 calculates the phase change of the reflected return light since the previous measurement, for example, as a phase difference from the previous measurement at the same place, the reflected return light being scattered at each point on the optical fiber 200 and returned. This signal processing is a typical technology of DAS and thus detailed description is omitted.

The acquisition processing unit 101 derives measurement data in the same form as that acquired when point-like electricity sensors are virtually sequentially arranged on the optical fiber 200. The measurement data is, for example, virtual sensor array output data obtained as a result of signal processing. The measurement data indicates the instantaneous intensity (waveform) of vibration or sound detected by the optical fiber 200 at each time point or at each point (sensor position) on the optical fiber 200. The acquisition processing unit 101 outputs the measurement data to the information provision unit 120.

### [Operation]

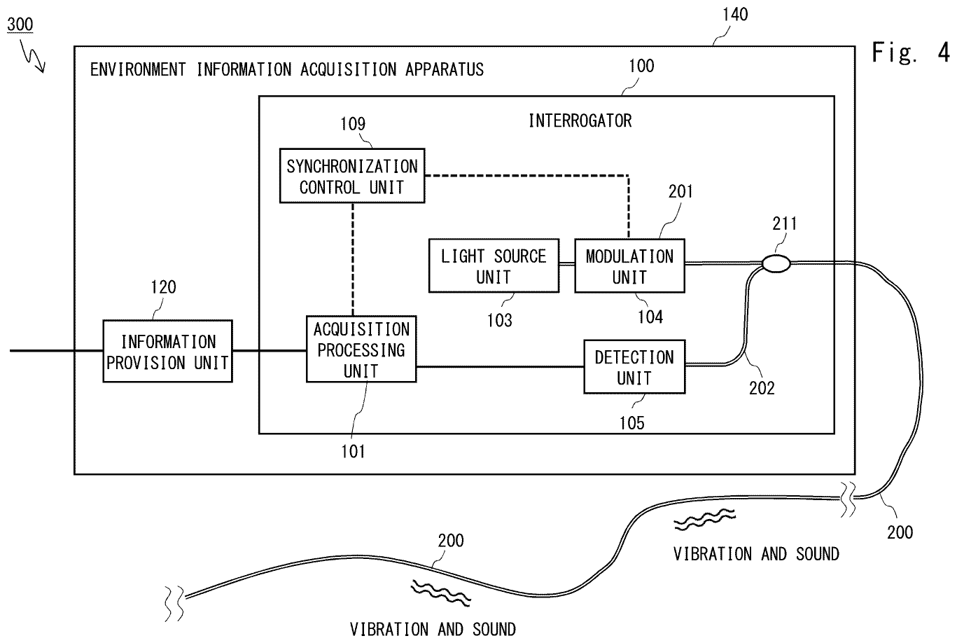

An exemplary operation process of the environment information acquisition apparatus 140 according to the present first example embodiment will be described below with reference to FIG. 5.

As illustrated in FIG. 5, the interrogator 100 outputs probe light to the optical fiber 200 and receives part of scattered light generated at each position on the optical fiber 200 as reflected return light. Then, the interrogator 100 acquires environment information (for example, vibration or sound) applied to each position on the optical fiber 200 based on the reflected return light (step S1).

The acceleration sensor 30 or the microphone 31 detects vibration or sound applied to the interrogator 100 (step S2).

When it is detected that vibration or sound is applied to the interrogator 100 (Yes at step S3), the information provision unit 120 adds a mark indicating reliability decrease to measurement data of the environment information and outputs the measurement data to which the mark is added to the outside (step S4).

When it is not detected that vibration or sound is applied to the interrogator 100 (No at step S3), the information provision unit 120 outputs only the measurement data of the environment information to the outside (step S5).

### [Effect]

According to the present first example embodiment, the acceleration sensor 30 and the microphone 31 configured to detect vibration and sound applied to the interrogator 100 are attached to the interrogator 100.

Accordingly, vibration or sound application to the interrogator 100 can be detected, and thus it can be determined that anomalous information not having occurred to the optical fiber 200 is potentially superimposed on measurement data of environment information acquired by the interrogator 100 when the vibration or sound is applied.

Moreover, according to the present first example embodiment, when vibration or sound application to the interrogator 100 is detected by the acceleration sensor 30 or the microphone 31, the information provision unit 120 adds a mark indicating reliability decrease to measurement data of environment information acquired by the interrogator 100 and outputs the measurement data to the outside.

Accordingly, even when vibration or sound propagates to the interrogator 100 and a noise-shaped object appears in the measurement data, processing can be appropriately performed at a following system that uses the measurement data. For example, in a case of an earthquake hypocenter analysis system, it is possible to avoid false analysis of a shake of the interrogator 100 as an earthquake at a remote place.

### Second Example Embodiment

The present second example embodiment is an example in which vibration or sound propagation to the interrogator 100 is detected by performing pattern analysis on measurement data of environment information acquired by the interrogator 100. Operation subsequent to the detection of vibration or sound application to the interrogator 100 is the same as in the first example embodiment.

Some different characteristics are observed between measurement data in FIG. 2A when the optical fiber 200 is shaken by an earthquake and measurement data in FIG. 2B when vibration is applied to the interrogator 100. In the measurement data in the case of an earthquake, an envelope amplitude at each place has a shape with a tail behind it, but such a tail is not observed in the measurement data in the case in which the interrogator 100 is shaken. In the case in which the interrogator 100 is shaken, a change appears at a certain time point at once irrespective of the place of the optical fiber 200. Since the easiness of propagation of a ground shake to the optical fiber 200 differs depending on the installation situation of the optical fiber 200 at each point, a difference in the easiness of propagation is observed as a vertical grayscale line in the measurement data. Similarly, a vertical grayscale line attributable to the installation situation of the optical fiber 200 appears in the measurement data in the case of an earthquake. However, no such grayscale difference attributable to the installation situation appears in the measurement data in the case in which the interrogator 100 is shaken.

A shake of the interrogator 100 can be detected through pattern identification of such characteristic differences. Such an identification function to store pattern characteristics as identification conditions in advance and perform pattern identification may be implemented at, for example, the information provision unit 120.

Accordingly, the same detection as in the first example embodiment can be performed without using sensors such as the acceleration sensor 30 and the microphone 31. However, the present second example embodiment is effective only when characteristic differences clearly appear in a pattern, and vibration or sound applied to the interrogator 100 can be more reliably sensed according to the first example embodiment.

In the operation subsequent to detection of a shake of the interrogator 100, the information provision unit 120 adds a mark indicating reliability decrease to measurement data of environment information as in the first example embodiment.

### [Effect]

According to the present second example embodiment, vibration or sound propagation to the interrogator 100 is detected through pattern analysis of measurement data of environment information. Accordingly, a shake of the interrogator 100 can be detected based on the measurement data without attaching sensors such as the acceleration sensor 30 and the microphone 31 to the interrogator 100. As a result, similarly to the first example embodiment, it can be determined that anomalous information not having occurred to the optical fiber 200 is potentially superimposed on measurement data of environment information acquired by the interrogator 100 when the vibration or sound is applied.

Moreover, according to the present second example embodiment, information indicating reliability decrease is added to measurement data of environment information as in the first example embodiment. Accordingly, even when vibration or sound is applied to the interrogator 100, appropriate processing can be performed at a following system that uses the measurement data.

### Third Example Embodiment

In a third example embodiment, a shake of the interrogator 100 is detected by sensors such as the acceleration sensor 30 and the microphone 31 as in the first example embodiment. Then, influence of the shake of the interrogator 100 on measurement data of environment information is removed by calculation. Such a function may be implemented at, for example, the information provision unit 120.

Similarly to the first example embodiment, a shake of the interrogator 100 can be detected by sensors such as the acceleration sensor 30 and the microphone 31. The correlation between a waveform detected by a sensor such as the acceleration sensor 30 or the microphone 31 and influence (waveform) that appears in measurement data of environment information is determined in advance by artificially applying vibration or sound to the interrogator 100. In this case, the artificial vibration or sound is prevented from propagating to the optical fiber 200.

In operation, a corrected waveform is generated based on a waveform detected by a sensor such as the acceleration sensor 30 or the microphone 31 and the above-described correlation determined in advance, influence of a shake of the interrogator 100 is removed by subtracting the corrected waveform from measurement data of environment information acquired by the interrogator 100, and then, the measurement data is output.

Since this method manipulates measurement data of environment information acquired by the interrogator 100, the accuracy of the entire measurement data is potentially lost with inappropriate correction. Thus, first of all, it is fundamental to provide vibration-free and soundproof measure to the housing structure housing the interrogator 100 so that vibration and sound do not propagate to the interrogator 100. It is desirable to perform, for vibration or sound propagating despite the measures, active cancellation as in the present third example embodiment.

### [Effect]

According to the present third example embodiment, vibration or sound applied to the interrogator 100 is detected by a sensor such as the acceleration sensor 30 or the microphone 31 as in the first example embodiment. Accordingly, it can be determined that anomalous information not having occurred to the optical fiber 200 is potentially superimposed on measurement data of environment information acquired by the interrogator 100 when the vibration or sound is applied.

Moreover, according to the present third example embodiment, the correlation between a waveform detected by the above-described sensor and influence (waveform) that appears in measurement data of environment information when vibration or sound is artificially applied to the interrogator 100 is determined in advance. Then, in operation, a corrected waveform is generated based on a waveform detected by the above-described sensor and the above-described correlation, and influence of vibration or sound application to the interrogator 100 is removed from measurement data of environment information. Accordingly, even when vibration or sound is applied to the interrogator 100, influence of the vibration or sound on measurement data of environment information can be removed by calculation. As a result, influence of the vibration or sound application to the interrogator 100 is not transferred to a following system that uses the measurement data, and thus processing can be appropriately performed.

Note that, according to the present third example embodiment, influence of vibration or sound application to the interrogator 100 is removed from measurement data of environment information. Thus, it is not essential to add information indicating reliability decrease to measurement data of environment information as in the first and second example embodiments.

### Fourth Example Embodiment

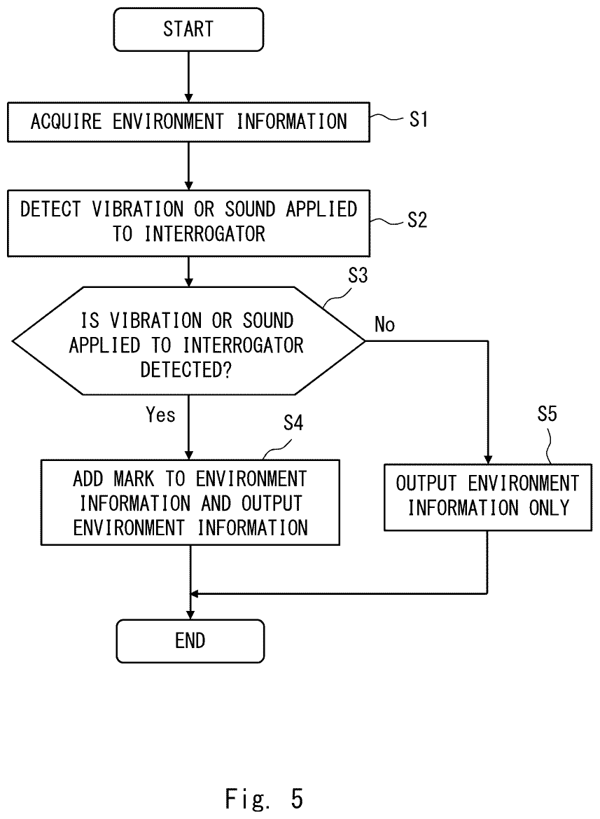

An exemplary configuration of an environment information acquisition apparatus 400 according to the present fourth example embodiment will be described below with reference to FIG. 6. As illustrated in FIG. 6, the environment information acquisition apparatus 400 according to the present fourth example embodiment includes an information acquisition unit 410, a vibration-sound detection unit 420, and an information provision unit 430.

The information acquisition unit 410 receives, from an optical fiber 500, an optical signal having a pattern in accordance with environment information (for example, vibration or sound) applied to the optical fiber 500, and acquires the environment information based on the optical signal. The information acquisition unit 410 corresponds to, for example, the interrogator 100.

The vibration-sound detection unit 420 detects vibration and sound applied only to the information acquisition unit 410.

The information provision unit 430 outputs measurement data representing the environment information acquired by the information acquisition unit 410 to the outside. The information provision unit 430 corresponds to, for example, the information provision unit 120.

According to the present fourth example embodiment, the vibration-sound detection unit 420 configured to detect vibration and sound applied to the information acquisition unit 410 is provided. Accordingly, vibration or sound application to the information acquisition unit 410 can be detected, and thus it can be determined that anomalous information not having occurred to the optical fiber 200 is potentially superimposed on measurement data of environment information acquired by the information acquisition unit 410 when the vibration or sound is applied.

Note that, when vibration or sound application to the information acquisition unit 410 is detected by the vibration-sound detection unit 420, the information provision unit 430 may add, to measurement data, information about the vibration or sound to the information acquisition unit 410.

The vibration-sound detection unit 420 may include a vibration sensor configured to detect vibration applied to the information acquisition unit 410 and may detect the vibration applied to the information acquisition unit 410 based on an output from the vibration sensor. The vibration sensor corresponds to, for example, the acceleration sensor 30.

The vibration-sound detection unit 420 may include a sound sensor configured to detect sound applied to the information acquisition unit 410 and may detect the sound applied to the information acquisition unit 410 based on an output from the sound sensor. The sound sensor corresponds to, for example, the microphone 31.

The vibration-sound detection unit 420 may detect vibration or sound applied to the information acquisition unit 410 based on whether measurement data includes a pattern that characteristically appears when vibration or sound is applied to the information acquisition unit 410.

The vibration-sound detection unit 420 may include a sensor configured to detect vibration and sound applied to the information acquisition unit 410 and may detect the vibration or sound applied to the information acquisition unit 410 based on an output from the sensor. The sensor corresponds to, for example, the acceleration sensor 30 or the microphone 31. The information provision unit 430 may determine in advance the correlation between an output from the sensor and a waveform that appears in measurement data when vibration or sound is applied to the information acquisition unit 410. When vibration or sound application to the information acquisition unit 410 is detected by the vibration-sound detection unit 420, the information provision unit 430 may perform processing of removing influence of the vibration or sound applied to the information acquisition unit 410 from measurement data based on an output from the sensor and the correlation.

The information acquisition unit 410 may receive Rayleigh scattering reflected light as an optical signal and acquire environment information by optical fiber sensing (for example, distributed acoustic sensing) using the Rayleigh scattering reflected light.

### <Hardware Configuration of Environment Information Acquisition Apparatuses According to Embodiments>

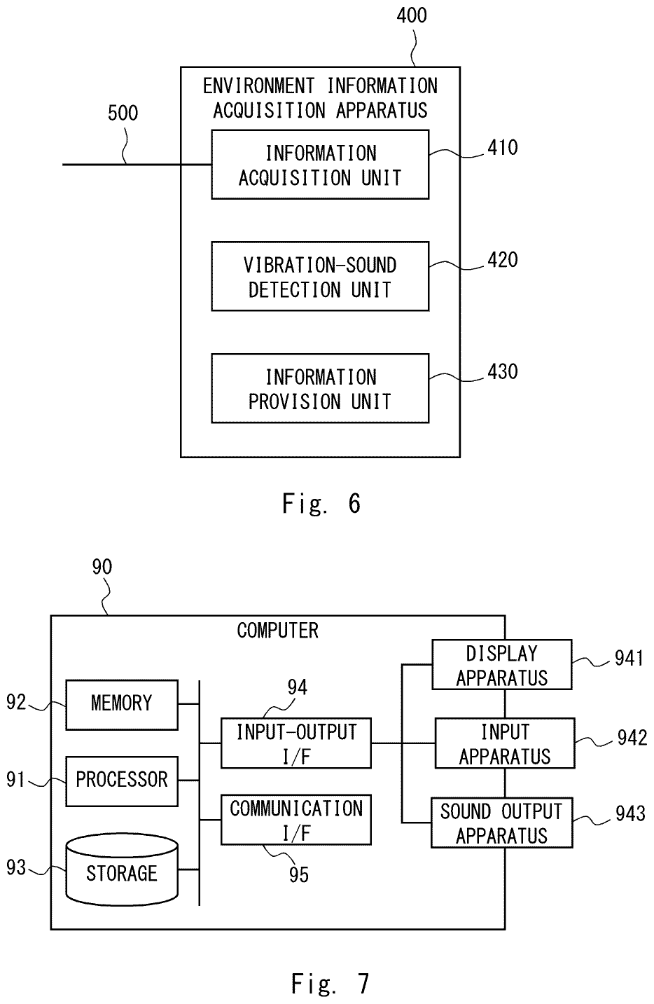

A hardware configuration of a computer 90 configured to implement the environment information acquisition apparatuses 140 and 400 according to the first to fourth example embodiments will be described below with reference to FIG. 7.

As illustrated in FIG. 7, the computer 90 includes, for example, a processor 91, a memory 92, a storage 93, an input-output interface (input-output I/F) 94, and a communication interface (communication I/F) 95. The processor 91, the memory 92, the storage 93, the input-output interface 94, and the communication interface 95 are connected to each other through a data transmission path for mutually transmitting and receiving data.

The processor 91 is an arithmetic processing apparatus such as a central processing unit (CPU) or a graphics processing unit (GPU). The memory 92 is a memory such as a random access memory (RAM) or a read only memory (ROM). The storage 93 is a storage apparatus such as a hard disk drive (HDD), a solid state drive (SSD), or a memory card. Alternatively, the storage 93 may be a memory such as a RAM or a ROM.

The storage 93 stores programs that implement functions of constituent components included in the environment information acquisition apparatuses 140 and 400. The processor 91 executes each program to implement the function of the corresponding constituent component included in the environment information acquisition apparatuses 140 and 400. When executing each above-described program, the processor 91 may execute the program after reading or without reading the program onto the memory 92. The memory 92 and the storage 93 also function to store information and data held by each constituent component included in the environment information acquisition apparatuses 140 and 400.

The above-described programs are stored by using various types of non-transitory computer-readable media and can be supplied to a computer (including the computer 90). The non-transitory computer-readable media include various types of tangible storage media. Examples of the non-transitory computer-readable media include a magnetic record medium (for example, a flexible disk, a magnetic tape, and a hard disk drive), a magneto-optical record medium (for example, a magneto optical disc), a compact disc ROM (CD-ROM), a CD-recordable (CD-R), a CD-rewritable (CD-R/W), a semiconductor memory (for example, a mask ROM, a programmable ROM (PROM), and an erasable PROM (EPROM), a flash ROM, and a RAM. The programs may be supplied to a computer through various types of transitory computer readable media. Examples of the transitory computer-readable media include an electric signal, an optical signal, and an electromagnetic wave. The transitory computer-readable media can supply the programs to a computer through a wired communication path such as an electrical line or an optical fiber or through a wireless communication path.

The input-output interface 94 is connectable to, for example, a display apparatus 941, an input apparatus 942, and a sound output apparatus 943. The display apparatus 941 is an apparatus such as a liquid crystal display (LCD), a cathode-ray tube (CRT) display, or a monitor, which displays a screen corresponding to drawing data processed by the processor 91. The input apparatus 942 is an apparatus that receives an operation input from an operator, and is, for example, a keyboard, a mouse, or a touch sensor. The display apparatus 941 and the input apparatus 942 may be integrated and implemented as a touch panel. The sound output apparatus 943 is an apparatus such as a speaker, which acoustically outputs sound corresponding to acoustic data processed by the processor 91.

The communication interface 95 transmits and receives data to and from an external apparatus. The communication interface 95 communicates with the external apparatus through, for example, a wired communication path or a wireless communication path.

The present disclosure is described above with reference to the example embodiments but not limited to the above-described example embodiments. The configurations and details of the present disclosure may be provided with various modifications that could be understood by the skilled person in the art within the scope of the present disclosure.

### REFERENCE SIGNS LIST

30 ACCELERATION SENSOR
31 MICROPHONE
100 INTERROGATOR
120 INFORMATION PROVISION UNIT
140 ENVIRONMENT INFORMATION ACQUISITION APPARATUS
200 OPTICAL FIBER
300 ENVIRONMENT INFORMATION ACQUISITION SYSTEM
400 ENVIRONMENT INFORMATION ACQUISITION APPARATUS
410 INFORMATION ACQUISITION UNIT
420 VIBRATION-SOUND DETECTION UNIT
430 INFORMATION PROVISION UNIT
500 OPTICAL FIBER

What is claimed is:

1. An environment information acquisition apparatus comprising:
at least one memory storing instructions; and
at least one processor configured to execute the instructions to
receive, by an information acquisition unit, from an optical fiber, an optical signal including a pattern in accordance with environment information applied to the optical fiber and acquire the environment information based on the optical signal;
output measurement data representing the environment information to outside; and
detect vibration or sound applied to the information acquisition unit.

2. The environment information acquisition apparatus according to claim 1, wherein when application of vibration or sound to the information acquisition unit is detected, the at least one processor is further configured to execute the instructions to add, to the measurement data, information about the vibration or sound to the information acquisition unit.

3. The environment information acquisition apparatus according to claim 1, further comprising a vibration sensor configured to detect vibration applied to the information acquisition unit, wherein the at least one processor is further configured to execute the instructions to detect vibration applied to the information acquisition unit based on an output from the vibration sensor.

4. The environment information acquisition apparatus according to claim 1, further comprising a sound sensor configured to detect sound applied to the information acquisition unit, wherein the at least one processor is further configured to execute the instructions to detect sound applied to the information acquisition unit based on an output from the sound sensor.

5. The environment information acquisition apparatus according to claim 1, wherein the at least one processor is further configured to execute the instructions to detect vibration or sound applied to the information acquisition unit based on whether the measurement data includes a pattern that characteristically appears when vibration or sound is applied to the information acquisition unit.

6. The environment information acquisition apparatus according to claim 1, further comprising a sensor configured to detect vibration or sound applied to the information acquisition unit, wherein
the at least one processor is further configured to execute the instructions to
detect vibration or sound applied to the information acquisition unit based on an output from the sensor,
determine in advance a correlation between an output from the sensor and a waveform that appears in the measurement data when vibration or sound is applied to the information acquisition unit, and
when application of vibration or sound to the information acquisition unit is detected, perform processing of removing influence of the vibration or sound applied to the information acquisition unit from the measurement data based on an output from the sensor and the correlation.

7. The environment information acquisition apparatus according to claim 1, wherein the at least one processor is further configured to execute the instructions to receive, by the information acquisition unit, Rayleigh scattering reflected light as the optical signal and acquires the environment information by optical fiber sensing using the Rayleigh scattering reflected light.

8. An environment information acquisition method performed by an environment information acquisition apparatus, the environment information acquisition method comprising:
a step of receiving, by an information acquisition unit, from an optical fiber, an optical signal including a pattern in accordance with environment information applied to the optical fiber and acquiring the environment information based on the optical signal;
a step of outputting measurement data representing the environment information to outside; and
a step of detecting vibration or sound applied to the information acquisition unit.

9. A non-transitory computer-readable medium storing a program for causing a computer to execute:
a procedure of receiving, by an information acquisition unit, from an optical fiber, an optical signal including a pattern in accordance with environment information applied to the optical fiber and acquiring the environment information based on the optical signal;
a procedure of outputting measurement data representing the environment information to outside; and
a procedure of detecting vibration or sound applied to the information acquisition unit.
